(19) United States
(12) Patent Application Publication
(10) Pub. No.: US 2019/0380375 A1
(43) Pub. Date: Dec. 19, 2019

(54) Filled Hollow Body Consisting of Sucrose, Glucose Syrup and Fruit Fibers

(71) Applicant: Anna FUCHS, Hamburg (DE)

(72) Inventor: Anna FUCHS, Hamburg (DE)

(21) Appl. No.: 16/330,603

(22) PCT Filed: Aug. 28, 2017
(86) PCT No.: PCT/DE2017/100723

§ 371 Date: Mar. 5, 2019

(30) Foreign Application Priority Data
Sep. 6, 2016 (DE) 10 2016 116 600.6

(51) Int. Cl. A23P 10/30; A23L 21/25; A23P 20/25; A23F 3/40; A23G 3/34; A23G 3/48; A23G 3/54; A23G 3/42

(52) U.S. Cl. CPC A23P 10/30; A23L 21/25; A23P 20/25; A23F 3/405; A23V 2002/00; A23G 3/343; A23G 3/48; A23G 3/545; A23G 3/42; A23G 3/0065

(57) ABSTRACT

The invention related to a body with a shell forming a hollow body and filling a material surrounding said shell, characterized in that the shell comprises sucrose, glucose syrup and fruit fibers.

This invention concerns an object with a casing made of a casing material and a filler enveloped by the casing. The invention particularly concerns a storable casing for holding liquid honey.

Such objects are widely known as medicinal capsules or in the food industry, for example in the form of filled candies. Regardless of the intended basic purpose, the structure and the effect of the casing and the filler can deviate strongly from each other and can possibly combine several functions in themselves.

A medicinal casing can thus for example be free of active ingredients and function only as mechanical and/or enzymatic protection of the filler acting as a drug. However, the casing fulfills both a protective and a flavoring function in the case of foods.

Since they tend to dissolve the casing and therewith the entire object because of their water content, liquid fillers impose special requirements on the storage stability of the materials used to produce the casing.

Syrup-filled pearls used for preparing Bubble Tea (also called “Pearl Milk Tea” or “Boba”), for example, have a casing made of alginates, which bursts when bitten into and releases its contents. It is also a characteristic of these balls that the casing is transparent and the filler is visible through the casing.

However, Bubble Tea is not widely distributed since, on one hand, the negative health aspects of the syrups and alginates used were debated and, on the other hand, the solubility of the balls, even in hot tea, is low and the balls must therefore be opened by crunching them. The balls used for Bubble Tea are additionally only stable with storage over a short time period, only when cooled and vacuum-packed in damp conditions.

While other casing materials, e.g. isomalt, are also transparent, they only have a very low storage stability, so that while they can be used to produce encased fillers, they must be consumed immediately after they are produced.

It was the original object of this invention to, in particular, envelop liquid honey in a storage-stable way so that it can, in particular, be used—as a pure natural product—for sweetening teas. In doing so, the casing should be transparent and the product should be altogether harmless to health, long-term storable and soluble in hot beverages.

It was therefore the object of this invention to devise an object of the aforesaid structure having a storage-stable casing, in particular to hold liquid honey. The object, particularly when filled with honey, should not have to be heated to over 40° C. for the casing to dissolve and release the honey.

This task is accomplished according to the invention by way of the object with the characteristics of Claim 1. The subsidiary claims show advantageous embodiments of the invention.

It is the basic idea of this invention to create an object with a casing made of a casing material, a casing forming a hollow body and a filler enveloped by the casing, with the casing and/or the casing material consisting of saccharose, glucose syrup and fruit fibers. The casing thus encloses the filler in the hollow body formed by the casing.

It was accidentally discovered in several series of experiments that a casing material made of saccharose, glucose syrup and fruit fibers fulfills the requirements regarding transparency and storage stability when it holds liquid honey. The casing also dissolves in liquid media, so that an application for sweetening hot beverages is conceivable.

It was recognized at the same time that the use of the casing material does not have to be limited to encasing liquid honey or other liquids. The casing material can rather in principle be used for producing the aforesaid objects and can contain drugs as a filler aside from food.

Granulates, powders, syrups or pastes can thus be used as fillers, e.g. tea granulates, elderflower syrup, but also coffee and cocoa blends, spice mixtures for health teas or mixtures for producing punch.

The casing can be cast as a round ball, cuboid or cube-shaped or ellipsoidal. In doing so, the casing itself—contrary to coatings known from the state of the art—constitutes a hollow body, which is inherently stable.

The casing made of saccharose, glucose syrup and fruit fibers is transparent. It is however also quite possible to dye the casing. It is thus, for example, possible to color the casing material with honey, so that—if liquid honey is used as the filler—a consistent and attractive product can be offered.

Apple, orange or citrus fibers can, for example, be used as fruit fibers. Citrus fibers are particularly suitable for sweetening beverages with liquid honey.

The glucose syrup is preferably a low level hydrolyzed glucose syrup, i.e. it has a Dextrose Equivalent (DE) of less than DE44. The glucose syrup used particularly has a Dextrose Equivalent of DE 42.5.

To ensure an adequate storage stability, the dry weight of the casing material is at most 96%, the glass transition temperature lies between 50° C. and 60° C. (inclusively in each case).

The casing material furthermore preferably has a water activity of α_{w}=0.3 to α_{w}=0.5. The casing material particularly preferably has a water activity of α_{w}=0.4 to α_{w}=0.5. This ensures that liquid honey, which has a similar water activity, does not attack the casing and that the object of this invention remains altogether stable for a long time.

The casing and/or casing material particularly contains 24.99-33.99 wt-% glucose, 66-75 wt-% glucose syrup and 0.01-0.1 wt-% fruit fibers. Citrus fibers are particularly preferred as fruit fibers.

A particularly preferred embodiment is achieved if the casing and/or the casing material has a composition of 24.9-33.9 wt-% glucose, 66-75 wt-% glucose syrup and 0.1 wt % fruit fibers, with citrus fibers being preferably used as fruit fibers.

The hollow body preferably accepts a liquid as a filler. The object produced according to this invention is, in any case, particularly suitable for holding liquids, in particular liquid honey. Dry materials can also be encased.

The filler is preferably a food. The food, liquid honey, is particularly preferred.

A process for producing a casing forming a closed hollow body is lastly claimed; this process comprises the following steps:
a. preparing a mixture of 24.99-33.99 wt-% glucose, 66-75 wt-% glucose syrup and 0.01-0.1 wt-% fruit fibers;
b. producing a solution consisting of 70 wt-% of the mixture and 30 wt-% water;
c. allowing the solution to be heated and evaporated until a dry weight of 90% to 96% is achieved; and
d. allowing the evaporated solution to cool and solidify while forming a casing in the form of a closed hollow body.

Step d. preferably comprises enclosure of a filler in the casing while the closed hollow body is being formed. For example, two hemispheres can be molded with the filler, where one hemisphere is filled with the filler and the other hemisphere is connected to the filled hemisphere.

Citrus fibers are preferably used as fruit fibers.

Alternatively, the additional step e. involves filling the closed hollow body with a filler through the casing.

This process is particularly suitable for use with a filler in the form of liquid honey.

The invention is based on the following observations and tests:

Saccharose can be cast into arbitrary shapes from a hot solution and then cooled into the amorphous glass state. A solid and transparent glass, which has the mechanical stability necessary for it to be used as a casing material, forms after cooling. The combination of saccharose and glucose syrup entails a delay in crystallization, so that such a casing material is less susceptible to crystallization and the formation of white discolorations during storage.

Hard caramels known from the state of the art often consist of saccharose and glucose syrup. They have a low water content of 1 to 2% (m/m) and a very low water activity (α_{w}-value) of<0.2. But honey has an α_{w}-value of 0.57 to 0.6. To obtain a ball, which is stable at room temperature in the long term, it is necessary for the casing and the honey core to have approximately the same water activity. Water would otherwise migrate from the material with higher α_{w}-value to the material with lower α_{w}-value in the course of the storage time. The consequence would be crystallization in the casing, with turbidity and mechanical instability.

If one increases the water content of the saccharose-glucose syrup glasses usually used for candies, their α_{w}-value also increases. But the material no longer hardens and remains in a liquid and sticky condition.

By adding at most 0.1% (m/m) citrus fibers to the saccharose-glucose syrup mixture, it was possible to increase the water content of the glasses to at most 5% and it was nevertheless possible to produce a solid casing with sufficient mechanical stability for encapsulating honey. Because of the higher water content, the water activity could be increased to 0.33 and it thus lies in an acceptable range regarding the expected moisture exchange with the honey.

In a particularly preferred final formulation, 33.9% saccharose, 66% glucose syrup and 0.1% fruit fibers, particularly citrus fibers, are put into water and boiled down to a dry material content of 95% (m/m). A glucose syrup content that is too low leads to crystallization of the saccharose and to mechanically unstable honey balls during storage. A glucose syrup content that is too high leads to a lower solubility of the balls in water as well as to a surface that is too sticky. Too high a fraction of fruit fibers causes the casing material to burn and to turn dark.

The invention is described in greater detail using a particularly preferred example embodiment:

For this special example embodiment, transparent balls with a bee honey filling, which dissolve without forming streaks and residues, are to be produced for the catering trade and supermarkets, for use in hot beverages, e.g. tea. A hollow body, which is stable at room temperature and made of non-animal, natural material is to be used as the casing.

To produce the casing (sugar casing) the raw materials (consisting of 24.99-33.99 wt-% saccharose (Nordzucker), 66-75 wt-% glucose syrup (Glucose Syrup C Sweet 01444—Cargill Germany GmbH, Krefeld) and 0.01-0.1 wt-% citrus fibers (Herbacel AQ Plus Citrus—N 01—Herbafood Ingredients GmbH, Werder (Havel)) were dissolved upon the addition of 30% water under constant agitation and brought to the boil until the desired dry substance content was within the range of 90% to 96%, most preferably 95%. The casing material was cast into the desired shape. The sugar mass was solidified in the mold at room temperature.

After solidifying, the hollow bodies were filled with liquid honey and the puncture in the casing was closed with casing material.

In carrying out this operation, attention had to be paid, on one hand, to the water activity of the casing material. To obtain a ball with honey filling, which is stable at room temperature over the storage time, it is necessary for the casing and the core to have approximately the same water activity. Water would otherwise migrate from the material with higher α_{w}-value to the material with lower α_{w}-value in the course of storage. The consequence would be crystallization of the sugar due to the reduction of the glass transition temperature with increasing water content, along with turbidity and mechanical instability. It was therefore necessary to find a material system for the honey casing, which system has this relatively high α_{w}-value, but at the same time sufficient strength as well as a transparent appearance. Typical hard caramels only have an α_{w}-value of 0.20.

On the other hand, attention had to be paid to the glass transition temperature (Tg). This describes a critical temperature of amorphous systems, which entails a change of the mechanical characteristics of the system (sugar) when it is exceeded. Below the glass transition temperature sugar is in the so-called glassy state and is both solid and transparent.

If the ambient temperature increases above the glass transition temperature, the viscosity of the sugar decreases strongly and the sugar tends to crystallize, because of which the sugar can become cloudy. One calls this state rubber-like.

The glass transition temperature of a material system depends on its water content. The glass transition temperature decreases with increasing water content. On the other hand, a low glass transition temperature entails decreased mechanical stability of the hardened sugar caramels. It is for this reason that hard caramel formulations with as high a glass transition temperature as possible were sought in this project.

It was finally possible to produce a product that is storable and transparent with the present formulation and processing. The water activity of the hardened casing material within a range of α_{w}=0.3 to α_{w}=0.5 was quite close to the water activity of α_{w}=0.57 of the liquid honey used and was found to be adequate. The glass transition temperature between 50° C. and 60° C., which was achieved, was of advantage in allowing a transparent and storable casing to be produced.

Tests with casing material wall thicknesses of 1 to 3 mm could be performed by way of different mold covers. Storage tests showed that honey balls produced according to this invention are still stable and without visible haze after storage at room temperature for nine months.

The diameter of the balls that were produced was 25 mm with a total mass of about 12 g. The honey content in the total mass of the ball depends on the wall thickness: with a wall thickness of 2 mm it is 57%, at 3 mm it is 42%.

1. A product comprising
a casing forming a hollow body; and
a filler enveloped by the casing, wherein
the casing includes saccharose, glucose syrup and fruit fibers.

2. The product according to claim 1, wherein the casing contains sodium bicarbonate.

3. The product according to claim 1, wherein the fruit fibers are citrus fibers.

4. The product according to claim 1, wherein the glucose syrup is a low level hydrolyzed glucose syrup.

5. The product according to claim 1, wherein the glucose syrup has a dextrose equivalent of DE42.5.

6. The product according to claim 1, wherein the dry weight of the casing is at most 96%.

7. The product according to claim 1, wherein the casing has a glass transition temperature of 50° C. and 60° C.

8. The product according to claim 1, wherein the casing has a water activity of αw=0.3 to αw=0.5.

9. The product according to claim 1, wherein the casing has a water activity of αw=0.4 to αw=0.5.

10. The product according to claim 1, wherein the casing includes 24.99-33.99 wt.-% saccharose, 66-75 wt.-% glucose syrup and of 0.01-0.1 wt.-% fruit fibers.

11. The product according to claim 1, wherein the filler is a liquid.

12. The product according to claim 1, wherein the filler is a food.

13. The product according to claim 11, wherein the liquid is honey.

14. A method for producing a casing forming a closed hollow body, said method comprising:
a. preparing of a mixture of 24.99-33.99 wt.-% saccharose, 66-75 wt.-% glucose syrup and 0.01-0.1 wt.-% fruit fibers,
b. producing of a solution consisting of 70 wt.-% of the mixture and 30 wt.-% water,
c. heating and allowing the solution to be vaporized until it has a dry weight of 90% to 96%, and
d. cooling the evaporated solution and allowing the solution to solidify so as to form a casing in the form of a closed hollow body.

15. The method according to claim 14, wherein step d. includes the encapsulating a filler in the casing.

16. The method according to claim 14, further comprising step e., filling the closed hollow body through the casing with a filler.

17. The method according to claim 15, wherein the filler is liquid honey.

18. The method according to claim 16, wherein that the filler is liquid honey.

19. The product according to claim 1, wherein that the liquid is honey.

20. The product according to claim 12, wherein that the liquid is honey.
